(19) United States
(12) Patent Application Publication
(10) Pub. No.: US 2025/0359519 A1
(43) Pub. Date: Nov. 27, 2025

(54) CULTIVATION METHOD FOR FRUIT VEGETABLE PLANT

(71) Applicant: FUJIFILM CORPORATION, Tokyo (JP)

(72) Inventors: Takafumi HOSOKAWA, Kanagawa (JP); Masao SUGIMOTO, Kanagawa (JP)

(21) Appl. No.: 19/286,248

(22) Filed: Jul. 31, 2025

Related U.S. Application Data
(63) Continuation of application No. PCT/JP2023/047088, filed on Dec. 27, 2023.

(30) Foreign Application Priority Data
Feb. 21, 2023 (JP) 2023-025468

(51) Int. Cl. A01G 17/02

(52) U.S. Cl. CPC A01G 17/02

(57) ABSTRACT

A cultivation method for a fruit vegetable plant, including a cultivation step of cultivating a fruit vegetable plant by irradiating with artificial light and using a hydroponic method, in which in a part of a cultivation period in a state where a fruit vegetable plant body has two or more levels of flower clusters or fruit clusters and has two or more leaves with respect to one flower cluster or one fruit cluster, a nutrient solution having a nitrogen concentration of 10 ppm by mass or less is used.

### CROSS-REFERENCE TO RELATED APPLICATIONS

This application is a continuation of International Application No. PCT/JP2023/047088, filed on Dec. 27, 2023, which claims priority from Japanese Patent Application No. 2023-025468, filed on Feb. 21, 2023. The entire disclosure of each of the above applications is incorporated herein by reference.

### BACKGROUND OF THE INVENTION

1. Field of the Invention

The present invention relates to a cultivation method for a fruit vegetable plant.

2. Description of the Related Art

In recent years, there has been an increasing need for the production of vegetables in a plant factory using artificial light. In particular, the production technology of some leafy vegetables such as lettuce has been advanced, and the study of the cultivation method for a fruit vegetable plant such as a tomato is desired.

For example, JP6405260B describes a cultivation method for fruit vegetables, including a step of supplying a fertilizer, in which an average supply amount of a nitrogen component per day at a fruit enlargement initial stage in the fertilizer supply step is less than an average supply amount of a nitrogen component per day from a flowering period to before a fruit enlargement period, and the average supply amount of a nitrogen component per day at the fruit enlargement initial stage is 3/10 or more and 7/10 or less with respect to an average supply amount of a nitrogen component per day at a fruit setting period.

JP7014936B describes a vegetable production method, including a first step of performing seeding, a second step of causing a cotyledons to emerge from a seed in a first period, a third step of growing a vegetable in a second period subsequent to the first period, a fourth step of further growing the vegetable in a third period subsequent to the second period, and a fifth step of harvesting the vegetable, in which the vegetable is grown by irradiating the vegetable with first light in a later part of the second period, and is grown by irradiating with second light in the first period, an earlier part of the second period, and the third period, the first light having a first maximum value of a light intensity in a wavelength range of 420 nm to 490 nm and including at least a part of light in a wavelength range of 500 nm to 600 nm, the second light having a second maximum value of a light intensity in a wavelength range of 590 nm to 650 nm, having a peak light intensity less than the second maximum value in a visible light wavelength range of 500 nm or less, and including light in a wavelength range of 500 nm to 590 nm.

### SUMMARY OF THE INVENTION

In the cultivation of fruit vegetable plants, there is a demand for further improvement in the sugar content of the harvested fruit.

An object to be achieved by one embodiment of the present disclosure is to provide a cultivation method for a fruit vegetable plant capable of harvesting a fruit having a higher sugar content than that in the related art.

The present disclosure includes the following aspects.
<1>

A cultivation method for a fruit vegetable plant, comprising:
a cultivation step of cultivating a fruit vegetable plant by irradiating with artificial light and using a hydroponic method,
wherein in a part of a cultivation period in a state where a fruit vegetable plant body has two or more levels of flower clusters or fruit clusters and has two or more leaves with respect to one flower cluster or one fruit cluster, a nutrient solution having a nitrogen concentration of 10 ppm by mass or less is used.
<2>

The cultivation method for a fruit vegetable plant according to <1>, in which a start of a use of the nutrient solution having a nitrogen concentration of 10 ppm by mass or less occurs at any time point between 3 days before and 7 days after pinching of the fruit vegetable plant body.
<3>

The cultivation method for a fruit vegetable plant according to <2>, in which the pinching of the fruit vegetable plant body is performed after flower clusters are formed at three to five levels of the fruit vegetable plant body.
<4>

The cultivation method for a fruit vegetable plant according to any one of <1> to <3>, in which, in a case where a cultivation period in which the nutrient solution having a nitrogen concentration of 10 ppm by mass or less is used is defined as a second cultivation period, and a cultivation period before the nutrient solution having a nitrogen concentration of 10 ppm by mass or less is used is defined as a first cultivation period, a phosphorus concentration of the nutrient solution used in the second cultivation period is 1.4 times or more a phosphorus concentration of a nutrient solution used in the first cultivation period.
<522

The cultivation method for a fruit vegetable plant according to any one of <1> to <4>, in which the fruit vegetable plant is a Solanaceae plant or a Cucurbitaceae plant.
<6>

The cultivation method for a fruit vegetable plant according to any one of <1> to <5>, in which the fruit vegetable plant is a tomato.

According to one embodiment of the present disclosure, there is provided a cultivation method for a fruit vegetable plant capable of harvesting a fruit having a higher sugar content than that in the related art.

### DESCRIPTION OF THE PREFERRED EMBODIMENTS

Hereinafter, embodiments for performing the present disclosure are described in detail. However, the present disclosure is not limited to the following embodiments. In the following embodiments, the components (including elements, steps, and the like) are not essential unless otherwise specified. The same applies to numerical values and ranges thereof, which do not limit the present disclosure.

In the present disclosure, the numerical ranges shown using “to” include the numerical values described before and after “to” as the minimum value and the maximum value.

In a numerical range described in a stepwise manner in the present disclosure, an upper limit or a lower limit described in one numerical range may be replaced with an upper limit or a lower limit in another numerical range described in a stepwise manner. In addition, in a numerical range described in the present disclosure, an upper limit value or a lower limit value described in the numerical range may be replaced with a value described in an example.

In the present disclosure, “mass” and “weight” are synonymous.

In the present disclosure, the term “step” includes not only an independent step but also a step as long as a desired purpose of the step is achieved even in a case where the step cannot be clearly distinguished from other steps.

In the present disclosure, the “fruit vegetable plant” means a plant of which harvested product is a fruit.

In the present disclosure, the “fruit vegetable plant body” means a fruit vegetable plant that is growing. The fruit vegetable plant seedling means a fruit vegetable plant body in a state of a seedling among the fruit vegetable plant bodies.

In the present disclosure, the “nutrient solution” means a solution in which nutritional components (inorganic substances, organic substances) required for growth of a plant are dissolved in water or the like.

### Cultivation Method for Fruit Vegetable Plant

A cultivation method for a fruit vegetable plant according to the disclosure includes a cultivation step of cultivating a fruit vegetable plant by irradiating with artificial light and using a hydroponic method, and is characterized in that in a part of a cultivation period in a state where a fruit vegetable plant body has two or more levels of flower clusters or fruit clusters and has two or more leaves with respect to one flower cluster or one fruit cluster, a nutrient solution having a nitrogen concentration of 10 ppm by mass or less is used.

The cultivation method for a fruit vegetable plant according to the present disclosure is characterized in that a nutrient solution having a nitrogen concentration of 10 ppm by mass or less is used in a part of the above-described cultivation period, in other words, a nutrient solution having a nitrogen concentration of more than 10 ppm by mass is used in a period other than the period in which the nutrient solution having a nitrogen concentration of 10 ppm by mass or less is used. That is, the switching of the nutrient solution is performed at least once.

According to the cultivation method for a fruit vegetable plant of the present disclosure, it is possible to harvest a fruit having a higher sugar content than that in the related art. The reason for this is not clear, but is presumed as follows.

The present inventors have found that in a part of a cultivation period in a state where a fruit vegetable plant body has two or more levels of flower clusters or fruit clusters and has two or more leaves with respect to one flower cluster or one fruit cluster, a nutrient solution having a nitrogen concentration of 10 ppm by mass or less is used, thereby improving the sugar content of a harvested fruit.

It is presumed that by limiting the nitrogen concentration in the nutrient solution in a part of the cultivation period, stress is applied to the fruit vegetable plant body under growth, and the sugar content of the harvested fruit is increased.

On the other hand, JP6405260B does not describe a cultivation method for a fruit vegetable plant in an environment irradiated with artificial light. In addition, JP7014936B describes a cultivation method for leafy vegetables, but does not describe a cultivation method for fruit vegetable plants.

### Cultivation Step

The cultivation method for a fruit vegetable plant of the present disclosure includes a cultivation step of cultivating a fruit vegetable plant by irradiating with artificial light and using a hydroponic method.

### (Fruit Vegetable Plant)

The fruit vegetable plant is not particularly limited, and examples thereof include Solanaceae plants such as tomatoes, eggplants, and bell peppers; Cucurbitaceae plants such as melons, cucumbers, pumpkins, and zucchinis; Fabaceae plants such as green beans, peas, and broad beans; Rosaceae plants such as strawberries; Malvaceae plants such as okra; and Gramineae plants such as corn.

Among these, the cultivation method of the present disclosure is suitable for Solanaceae plants or Cucurbitaceae plants. The fruit vegetable plant cultivated by the cultivation method of the present disclosure is preferably Solanaceae plants or Cucurbitaceae plants, more preferably a tomato or a melon, and still more preferably a tomato.

The tomato includes a medium-sized tomato, a cherry tomato, a high-sugar tomato, and the like. In addition, the melon includes netted melons such as green flesh and orange flesh, and non-netted melons.

### (Irradiation With Artificial Light)

In the cultivation step, the temperature conditions can be adjusted by the artificial light with which the fruit vegetable plant body is irradiated. For example, the temperature can be adjusted to two or more temperature conditions of the light period temperature and the dark period temperature.

From the viewpoints of cultivation efficiency, achieving high sugar contents, and the like, the upper limit of the light period temperature is preferably 29° C. or lower, more preferably 28.5° C. or lower, and still more preferably 28° C. or lower.

From the viewpoints of cultivation efficiency, achieving high sugar contents, and the like, the lower limit of the light period temperature is preferably 15° C. or higher, more preferably 20° C. or higher, and still more preferably 25° C. or higher.

From the viewpoints of cultivation efficiency, achieving high sugar contents, and the like, the upper limit of the dark period temperature is preferably 25° C. or lower, more preferably 23° C. or lower, and still more preferably 22° C. or lower.

From the viewpoints of cultivation efficiency, achieving high sugar contents, and the like, the lower limit of the dark period temperature is preferably 10° C. or higher, more preferably 13° C. or higher, and still more preferably 15° C. or higher.

The light period temperature and the dark period temperature are measured by placing a thermometer at a position 1 cm away from the fruit vegetable plant body. As the thermometer, for example, a temperature/humidity sensor THA-3151 manufactured by T&D Corporation can be used.

In the present disclosure, the “light period” means a period during which the fruit vegetable plant body is subjected to irradiation by the light source. In addition, in the present disclosure, the “dark period” means a period during which the fruit vegetable plant body is not subjected to irradiation by the light source.

A method of controlling the light period temperature and the dark period temperature is not particularly limited and the light period temperature and the dark period temperature can be controlled by using a known method in the related art. For example, the controlling of the light period temperature and the dark period temperature can be performed by monitoring the light period temperature and the dark period temperature of the seedling raising environment with the above-described thermometer, and sending hot air or cold air as necessary.

From the viewpoints of cultivation efficiency, achieving high sugar contents, and the like, a ratio of the time of the light period to the time of the dark period (time of light period/time of dark period) is preferably 0.5 to 5, more preferably 1 to 4, and still more preferably 2 to 3.

The light source of the artificial light is not particularly limited, and examples thereof include semiconductor light sources such as a light emitting diode (LED), discharge lamps such as a fluorescent lamp, and the like. In the cultivation method for a fruit vegetable plant according to the present disclosure, it is preferable to use LEDs.

One type of LED may be used, or two or more types of LEDs may be used.

The LED may emit visible light such as red, blue, and yellow, or may emit invisible light of ultraviolet light (wavelength of 380 nm or less) or infrared light (wavelength of 780 nm or more). However, from a viewpoint of promoting photosynthesis of the fruit vegetable plant body, the LED preferably emits light in a wavelength range of 400 nm to 700 nm.

From the viewpoints of cultivation efficiency, achieving high sugar contents, and the like, the relative humidity in the cultivation step is preferably controlled within a range of 50% to 80%, and more preferably controlled within a range of 55% to 77%.

The relative humidity is measured by placing a hygrometer at a position 1 cm away from the fruit vegetable plant body. As the hygrometer, for example, a temperature/humidity sensor THA-3151 manufactured by T&D Corporation can be used.

A method of controlling the humidity is not particularly limited, and the humidity can be controlled by a known method in the related art. For example, the humidity condition can be controlled by monitoring the humidity of the cultivation environment with the above hygrometer and, as necessary, by using an air conditioning device having a humidifying function and a dehumidifying function.

From the viewpoints of cultivation efficiency, achieving high sugar contents, and the like, the intensity of the artificial light irradiated onto the fruit vegetable plant body in the cultivation step is preferably 200 μmol/m²/s to 800 μmol/m²/s, and more preferably 250 μmol/m²/s to 600 μmol/m²/s.

The intensity of light is measured by placing a light-receiving surface of a measuring instrument toward the light source at a position 1 cm away from the fruit vegetable plant body. As the measuring instrument, for example, a photon sensor (LI-190R, manufactured by LI-COR, Inc.) and the like can be used. In a case where the light sources are disposed in two or more directions from the fruit vegetable plant body, the total intensity of light measured by disposing the measuring instrument toward respective light sources is defined as the light intensity.

The intensity of light can be controlled by changing a type, the number, or the like of the light source (LED, fluorescent lamp, or the like) used, changing the distance between the light source and the fruit vegetable plant body, or using a dimmable light source.

The irradiation with artificial light may be performed from the upper surface direction of the fruit vegetable plant body or from the side surface direction thereof, but from the viewpoints of cultivation efficiency, space utilization efficiency, and the like, it is preferable to perform the irradiation from the upper surface direction.

In addition, the irradiation with the artificial light may be performed from both the side surface direction and the upper surface direction.

From the viewpoint of shortening the period until harvesting, in the cultivation step, the carbon dioxide concentration of the environment is preferably 300 ppm by volume to 2,000 ppm by volume, and more preferably 400 ppm by volume to 1,500 ppm by volume.

The carbon dioxide concentration is measured by placing a carbon dioxide meter at a position 1 cm away from the fruit vegetable plant body. As the carbon dioxide meter, for example, LI-850 manufactured by LI-COR, Inc. can be used.

The method of controlling the carbon dioxide concentration is not particularly limited, and the carbon dioxide concentration can be controlled by a known method in the related art. For example, the carbon dioxide concentration can be controlled by monitoring the carbon dioxide concentration in the environment with the above-described carbon dioxide meter and using an air conditioning device or the like, as necessary.

### (Hydroponic Method)

The cultivation step is performed by a hydroponic method.

The hydroponic method is not particularly limited, and examples thereof include a Deep Flow Technique hydroponic method, Nutrient Film Technique hydroponic method, aeroponics, and drip hydroponics in which a liquid fertilizer is added dropwise to a root portion or a root portion support.

### (Cultivation Period)

In the cultivation step, the period from the start of planting in the hydroponic method to harvesting is defined as the cultivation period.

The planting step is, for example, a step of planting the fruit vegetable plant seedling obtained in the seedling raising step described later at a predetermined position in an environment capable of hydroponic cultivation.

Usually, flowers are formed on the main stem of the fruit vegetable plant body at any time after planting.

In the present disclosure, a flower formed at the lowest position (a position closest to the root of the fruit vegetable plant body) on the main stem of the fruit vegetable plant body is referred to as a first flower cluster. In a case where the flower in the first flower cluster falls and fruit sets, the first flower cluster shall be referred to as a first fruit cluster. In addition, a flower formed at the lowest position on the main stem of the fruit vegetable plant body next to the first flower cluster or the first fruit cluster is referred to as a second flower cluster. Similarly, a flower cluster formed at the N-th level from the lowest position on the main stem of the fruit vegetable plant body is referred to as an N-th flower cluster, and a fruit cluster formed at the N-th level is referred to as an N-th fruit cluster.

After the flower cluster or the fruit cluster is formed, it is preferable to perform the pinching of the fruit vegetable plant body at a desired time. The pinching is to remove the apical portion of the fruit vegetable plant body to stop the elongation of the stem.

After pinching, it is preferable to harvest the fruit at a desired time. A preferred time for pinching will be described later.

The cultivation period is not particularly limited, but is preferably 70 days to 300 days, more preferably 80 days to 200 days, still more preferably 80 days to 150 days, and particularly preferably 90 days to 120 days.

### (Nutrient Solution)

In the cultivation step, a nutrient solution is used.

In the preparation of nutrient solution, a desired fertilizer composition can be adjusted by appropriately selecting and formulating a single fertilizer. The formulation program “Best Blend” provided by NPO Japan Hydroponic Society of Japan may be used for adjusting the fertilizer composition of the nutrient solution. The component composition of the nutrient solution can have a target component content by correctly formulating the single fertilizer. In a case of quantifying the components in the nutrient solution, an ion chromatography method or a high-frequency inductively coupled plasma (ICP) method can be used.

In the cultivation method for a fruit vegetable plant of the present disclosure, in a part of a cultivation period in a state where a fruit vegetable plant body has two or more levels of flower clusters or fruit clusters and has two or more leaves with respect to one flower cluster or one fruit cluster, a nutrient solution having a nitrogen concentration of 10 ppm by mass or less (hereinafter, also referred to as a “specific nutrient solution”) is used. Hereinafter, a period in which the nutrient solution having a nitrogen concentration of 10 ppm by mass or less is used is also referred to as a “specific nutrient solution use period”.

The nitrogen concentration in the specific nutrient solution is 10 ppm by mass or less, and it is preferably 7 ppm by mass or less. The lower limit value of the nitrogen concentration is not particularly limited, and may be 0 ppm by mass.

The start of a use of the specific nutrient solution is not particularly limited as long as the fruit vegetable plant body is in a state of having two or more levels of flower clusters or fruit clusters and having two or more leaves with respect to one flower cluster or fruit cluster.

From the viewpoints of cultivation efficiency, achieving high sugar contents, and the like, it is preferable that the start of a use of the specific nutrient solution occur at any time point between 3 days before and 7 days after the pinching of the fruit vegetable plant body.

For example, in a case where the use of the specific nutrient solution is started before the pinching of the fruit vegetable plant body, it is preferable to perform the pinching within 3 days after the start of the use of the specific nutrient solution.

In addition, in a case where the use of the specific nutrient solution is started after the pinching of the fruit vegetable plant body, it is preferable that the use of the specific nutrient solution is started within 7 days after the pinching.

It is also preferable that the start of a use of the specific nutrient solution occurs at the same time as the pinching of the fruit vegetable plant body.

Since the growth of the stem stops by the pinching, the specific nutrient solution is easily transported to the flower cluster, the fruit cluster, or the fruit present at the time point of the pinching, and the sugar content of the harvested fruit is higher.

In a case where the growth of the fruit has not progressed at the start point in time of the use of the specific nutrient solution, the effect of achieving high sugar contents based on the use of the specific nutrient solution is easily obtained.

Specifically, with respect to the flower cluster (for example, the flower cluster on the uppermost level) that has flowered at the start point in time of the use of the specific nutrient solution, the effect of increasing the sugar content of the fruit derived from the flower cluster is high.

Therefore, from the viewpoints of cultivation efficiency, achieving high sugar contents, and the like, the pinching of the fruit vegetable plant body is preferably performed after three to five levels of the flower clusters are formed on the fruit vegetable plant body, and more preferably performed after three to five levels of the flower clusters are formed on the fruit vegetable plant body and the flower cluster on the uppermost level is flowered. More specifically, the pinching of the fruit vegetable plant body is preferably performed after the flowering of the flower cluster on the uppermost level and before the fruiting.

The specific nutrient solution use period is not particularly limited, but is, for example, 7 days to 100 days.

As described above, in the cultivation method for a fruit vegetable plant according to the present disclosure, the cultivation step includes a specific nutrient solution use period, and a nutrient solution having a nitrogen concentration of more than 10 ppm is used for a period other than the specific nutrient solution use period. That is, in the cultivation step, the nutrient solution is switched at least once.

In the nutrient solution having a nitrogen concentration of more than 10 ppm by mass, the nitrogen concentration is preferably 30 ppm by mass or more, and more preferably 60 ppm by mass or more. The upper limit value of the nitrogen concentration is not particularly limited, and is, for example, 300 ppm by mass.

From the viewpoint of cultivation efficiency, it is preferable that the nutrient solution be switched once.

In addition, from the viewpoint of achieving high sugar contents, it is preferable to set a specific nutrient solution use period after setting a period of using the nutrient solution having a nitrogen concentration of more than 10 ppm by mass.

Furthermore, from the viewpoint of increasing the yield together with achieving high sugar contents, in a case where the specific nutrient solution use period is set as the second cultivation period and the cultivation period before the specific nutrient solution use period is set as the first cultivation period, the phosphorus concentration of the nutrient solution (that is, the specific nutrient solution) used in the second cultivation period is preferably 1.4 times or more and more preferably 1.6 times or more with respect to the phosphorus concentration of the nutrient solution used in the first cultivation period.

The upper limit value of the ratio of the phosphorus concentration of the nutrient solution used in the second cultivation period to the phosphorus concentration of the nutrient solution used in the first cultivation period is not particularly limited, and is, for example, 3.

### Seedling Raising Step

The cultivation method for a fruit vegetable plant of the present disclosure can include a seedling raising step. In the seedling raising step, a fruit vegetable plant body after germination is raised as a fruit vegetable plant seedling.

From the viewpoint of cultivation efficiency, seedling raising of the fruit vegetable plant is preferably performed by a hydroponic method, and more preferably performed by a Deep Flow Technique hydroponic method.

From the viewpoint of cultivation efficiency, in the seedling raising step, it is preferable to use a nutrient solution (nutrient solution having a nitrogen concentration of more than 10 ppm by mass) other than the specific nutrient solution.

In the seedling raising step, the light period and the dark period can be switched by irradiating the fruit vegetable plant after germination with artificial light, and it is preferable that the temperature conditions be adjusted between the light period and the dark period. For example, the temperature can be adjusted to two or more temperature conditions of the light period temperature and the dark period temperature.

From the viewpoint of shortening the period until budding, the upper limit of the light period temperature is preferably 29° C. or lower, more preferably 28.5° C. or lower, and still more preferably 28° C. or lower.

From the viewpoint of shortening the period until budding, the lower limit of the light period temperature is preferably 15° C. or higher, more preferably 20° C. or higher, and still more preferably 25° C. or higher.

From the viewpoint of shortening the period until budding, the upper limit of the dark period temperature is preferably 25° C. or lower, more preferably 23° C. or lower, and still more preferably 22° C. or lower.

From the viewpoint of shortening the period until budding, the lower limit of the dark period temperature is preferably 10° C. or higher, more preferably 13° C. or higher, and still more preferably 15° C. or higher.

The light source, wavelength, and the like of the artificial light can be used as described in the cultivation step.

From the viewpoints of cultivation efficiency, achieving high sugar contents, and the like, a ratio of the time of the light period to the time of the dark period (time of light period/time of dark period) is preferably 0.3 to 3 and more preferably 0.5 to 2.

From the viewpoints of cultivation efficiency, achieving high sugar contents, and the like, the relative humidity in the seedling raising step is preferably controlled within a range of 50% to 80%, and more preferably controlled within a range of 55% to 77%.

From the viewpoints of cultivation efficiency, achieving high sugar contents, and the like, the intensity of the artificial light irradiated onto the fruit vegetable plant body after germination in the seedling raising step is preferably 200 μmol/m²/s to 800 μmol/m²/s, and more preferably 250 μmol/m²/s to 600 μmol/m²/s.

The irradiation with artificial light may be performed from the upper surface direction of the fruit vegetable plant body after germination or from the side surface direction thereof, but from the viewpoints of cultivation efficiency, space utilization efficiency, and the like, it is preferable to perform the irradiation from the upper surface direction.

In addition, the irradiation with the artificial light may be performed from both the side surface direction and the upper surface direction.

From the viewpoint of shortening the period until harvesting, in the seedling raising step, the carbon dioxide concentration of the environment is preferably 300 ppm by volume to 2,000 ppm by volume, and more preferably 400 ppm by volume to 1,500 ppm by volume.

The period of the seedling raising step is not particularly limited, and from the viewpoints of growth potential after planting, shortening of the period until budding, and the like, the seedling raising period is preferably 5 days to 40 days, more preferably 10 days to 35 days, still more preferably 12 days to 30 days, and particularly preferably 15 days to 33 days.

In a case where the seedling raising step is performed by the hydroponic method, the support for supporting the fruit vegetable plant body after germination is not particularly limited, and it preferably has a material having moderate water permeability and water retention, and is more preferably a support table provided with a urethane sponge, a phenol resin sponge, rock wool, or a water retention sheet.

### Germination Step

The cultivation method for a fruit vegetable plant of the present disclosure can include a germination step. In the germination step, the seeds of the fruit vegetable plant used in the germination step are germinated.

A germination method is not particularly limited, and the germination can be performed by a known method in the related art. For example, the germination can be performed by sowing seeds of a fruit vegetable plant on the support sufficiently moistened with water and storing in a dark place. Examples of the support include the same support as the support used in the seedling raising step.

In addition, it is preferable to select fruit vegetable plants having a similar degree of growth from among the seeds of the fruit vegetable plants in which germination is confirmed and to carry out raising seedlings. Accordingly, the harvesting time of the fruit can be matched, and the cultivation efficiency can be improved.

The temperature in the germination step varies depending on the item and variety of the fruit vegetable plant to be used, but in a case of commercially available seeds, these are generally disclosed as the germination temperature. In addition, in a case where the germination temperature is unknown, it can be experimentally confirmed. Furthermore, depending on the item and variety of the fruit vegetable plant to be used, it may be necessary to perform a treatment such as dormancy breaking during germination. In the germination process, there are those that require light of a specific wavelength, those that require to be under darkness, and those germinates in any of the cases. These can be also known in the same manner as the germination temperature.

The relative humidity in the germination process is preferably 70% to 100% and particularly preferably 80% to 95%. By setting the relative humidity to this range, it is possible to prevent drying of a plant body in the germination period and to make the growth good.

The period required for the germination process is not determined to be constant, but the period is preferably a period until rooting and subsequent hypocotyl elongation start, generally about several days to one week. By applying this period to the germination process, the roots can be sufficiently grown, and at the same time, it is possible to avoid excessive hypocotyl elongation. Therefore, the growth of seedlings in the subsequent seedling raising process is made good and a period until flowering can be shortened, which is preferable.

### Fruit Sugar Content

In one embodiment of the cultivation method for a fruit vegetable plant of the present disclosure, the fruit vegetable plant is a tomato, and the Brix sugar content of the tomato is preferably 5.0% by mass or more, more preferably 5.5% by mass or more, still more preferably 6.0% by mass or more, and particularly preferably 7.0% by mass or more.

In the present disclosure, the “Brix sugar content” refers to a value in which a refractive index measured at 20° C. using a sugar content meter or a refractometer is converted into % by mass of a sucrose solution based on a conversion table of the International Commission for Uniform Methods of Sugar Analysis (ICUMSA). For example, in a case where a solution of 100 g contains x g of sucrose (water=100−x g), the Brix sugar content is x %.

In the present disclosure, the Brix sugar content of the tomato is measured by a sugar content measuring instrument (sugar content meter manufactured by Atago Co., Ltd.) after cutting the tomato in half along any plane in the longitudinal direction (direction orthogonal to the equatorial plane) of the tomato, crushing one of the halves into a liquid, and using the obtained liquid.

### EXAMPLES

Hereinafter, the above-described embodiment will be specifically described with reference to Examples, but the above-described embodiment is not limited to these Examples.

### Preparation of Nutrient Solutions A to F, and X

By formulating the single fertilizer, nutrient solutions containing each component shown in Table 1 and a trace component were prepared. In Table 1, the numerical values indicate the concentrations of each component, and the unit is “ppm by mass”. The N concentration is a value calculated based on the NO3-concentration. The P concentration is a value calculated based on the PO₄³⁻ concentration.

In addition to the components shown in Table 1, each nutrient solution contains the following components as trace components.
Mo: 30 ppb by mass
Zn: 150 ppb by mass
Fe: 1,750 ppb by mass
Cu: 80 ppb by mass
B: 350 ppb by mass
Mn: 560 ppb by mass
Ni: 50 ppb by mass

TABLE 1

| | N | P | NO₃⁻ | K⁺ | PO₄³⁻ | Ca²⁺ | SO₄²⁻ | Mg²⁺ |
|---|---|---|---|---|---|---|---|---|
| Nutrient solution A | 97.1 | 32.6 | 430 | 177 | 100 | 90 | 76 | 25 |
| Nutrient solution B | 0 | 32.6 | 0 | 177 | 100 | 90 | 76 | 25 |
| Nutrient solution C | 9.0 | 32.6 | 40 | 177 | 100 | 90 | 76 | 25 |
| Nutrient solution D | 0 | 65.3 | 0 | 177 | 200 | 90 | 76 | 25 |
| Nutrient solution E | 0 | 45.7 | 0 | 177 | 140 | 90 | 76 | 25 |
| Nutrient solution F | 0 | 42.4 | 0 | 177 | 130 | 90 | 76 | 25 |
| Nutrient solution X | 11.3 | 32.6 | 50 | 177 | 100 | 90 | 76 | 25 |

### Example 1

### (Germination Step)

Tomato seeds (variety: Momotaro York (registered trademark), manufactured by TAKII & Co., Ltd) were sown on a support A (5 cm × 5 cm × 2 cm foamed polyurethane) sufficiently containing pure water, stored for 3 days in a dark environment at a temperature of 28° C. and a relative humidity of 70%, and germinated to obtain a tomato plant seedling.

### (Seedling Raising Step)

The tomato plant seedling obtained in the above-described germination step was transplanted to a fruit vegetable plant hydroponic cultivation device that includes an artificial light irradiation device and a nutrient solution tank in which the nutrient solution A was contained, and raised seedlings for 20 days by a Deep Flow Technique hydroponic method.

### (Cultivation Step)

The obtained tomato plant seedlings (30 plants) were planted in an environment capable of controlling temperature, humidity, and the intensity of light, to start cultivation under the following condition 1. In the cultivation period, according to the conventional method, the pruning (such as side shoot cutting, leaf plucking, and the like) and the training were performed in a single-stemmed manner, and at a time point when three flower cluster (first flower cluster to third flower cluster) was set on the main branch and the flowering of the third flower cluster was then confirmed, pinching was performed while leaving the upper two leaves of the third flower cluster (first cultivation period). At the same time as the pinching, the nutrient solution to be supplied was changed from the nutrient solution A to the nutrient solution B (second cultivation period).

Each fruit cluster was thinned out such that the number of fruit setting was 2, the tomato fruit born up to the third flower cluster was harvested, and the cultivation was terminated.

### [Condition 1]

Light source: plant growth LED four-color type, PGL-200DWB26D, manufactured by Ryoden Corporation
Intensity of light: 450 μmol/m²·s
Light composition: in accordance with light emission behavior of the LED.
Light-dark cycle (light period/dark period): 17 hours/7 hours
Temperature: 27° C. (light period), 17° C. (dark period)
Relative humidity: 70%
Carbon dioxide concentration: 800 ppm
Nutrient solution used: nutrient solution A

### Example 2 to Example 5 and Comparative Example 2

In Example 2 to Example 5 and Comparative Example 2, cultivation was performed by the same method as in Example 1, except that the nutrient solution A was changed to the nutrient solution shown in Table 2.

### Example 6, Example 7, and Example 10

In Example 6, Example 7, and Example 10, cultivation was performed by the same method as in Example 3, except that the time of changing from the nutrient solution A to the nutrient solution B was changed to the time described in Table 2.

### Example 8

In Example 8, cultivation was performed by the same method as in Example 3, except that at the time when the flowering of the fourth flower cluster was confirmed after four flower clusters (first flower cluster to fourth flower cluster) were set on the main branch, pinching was performed while leaving the upper two leaves of the fourth flower cluster.

### Example 9

In Example 9, cultivation was performed by the same method as in Example 3, except that at the time when the flowering of the fifth flower cluster was confirmed after five flower clusters (first flower cluster to fifth flower cluster) were set on the main branch, pinching was performed while leaving the upper two leaves of the fifth flower cluster.

### Example 11

In Example 11, cultivation was performed by the same method as in Example 3, except that at the time when the flowering of the sixth flower cluster was confirmed after six flower clusters (first flower cluster to sixth flower cluster) were set on the main branch, pinching was performed while leaving the upper two leaves of the sixth flower cluster.

### Comparative Example 1

In Comparative Example 1, cultivation was performed by the same method as in Example 1, except that the nutrient solution to be supplied was not changed from the nutrient solution A.

### Evaluation

### [Average Number of Fruits Harvested, Average Fruit Weight, and Average Yield]

The average number of fruits harvested per plant, the average weight per fruit (average fruit weight), and the average weight (average yield) of fruits harvested per plant in Examples and Comparative Examples were calculated.

### [Average Brix Sugar Content]

The harvested tomato was cut into halves along any plane in the longitudinal direction (direction orthogonal to the equatorial plane), one of the divided halves was crushed into a juice-like form, and a part of the other half was measured with a sugar content measuring instrument (sugar content meter manufactured by Atago Co., Ltd.). The average value of the Brix sugar contents of the each fruit was calculated.

In Example 9, the average value of the fruits harvested at the third to fifth levels was adopted.

The evaluation results are shown in Table 2.

In Table 2, the first cultivation period means a period until the switching of the nutrient solution is performed in the cultivation step, and the second cultivation period means a period after the switching of the nutrient solution is performed. In Comparative Example 1, since the nutrient solution was not switched, the first cultivation period is described only.

The types of nutrient solutions used in the first cultivation period and the second cultivation period, and the nitrogen concentration and the phosphorus concentration contained in the nutrient solution are described. The units of the nitrogen concentration and the phosphorus concentration are “ppm by mass”.

The time of pinching was described as the highest levels of the flower cluster in a case where pinching was performed.

TABLE 2

| | | | | | | | | | Evaluation | | | |
|---|---|---|---|---|---|---|---|---|---|---|---|---|
| | | | | | | | | | Average | | | |
| | | Nutrient solution | | | | | | | number | | | Average |
| | | First cultivation period | | | Second cultivation period | | | | of fruits | Average | | Brix |
| | | | N | P | | N | P | | harvested | fruit | Average | sugar |
| | Time of | | concen- | concen- | | concen- | concen- | Time of | [Number/ | weight | yield | content |
| | pinching | Type | tration | tration | Type | tration | tration | switching | plant] | [g] | [g/plant] | [%] |
| Example 1 | Third flower | A | 97.1 | 32.6 | B | 0 | 32.6 | same time as | 5.8 | 56 | 325 | 6.6 |
| | cluster | | | | | | | pinching | | | | |
| Example 2 | Third flower | A | 97.1 | 32.6 | C | 9.0 | 32.6 | same time as | 5.9 | 60 | 354 | 6.0 |
| | cluster | | | | | | | pinching | | | | |
| Example 3 | Third flower | A | 97.1 | 32.6 | D | 0 | 65.3 | same time as | 6.0 | 112 | 672 | 8.1 |
| | cluster | | | | | | | pinching | | | | |
| Example 4 | Third flower | A | 97.1 | 32.6 | E | 0 | 45.7 | same time as | 6.0 | 105 | 630 | 7.7 |
| | cluster | | | | | | | pinching | | | | |
| Example 5 | Third flower | A | 97.1 | 32.6 | F | 0 | 42.4 | same time as | 5.9 | 80 | 472 | 6.8 |
| | cluster | | | | | | | pinching | | | | |
| Example 6 | Third flower | A | 97.1 | 32.6 | D | 0 | 65.3 | 3 days | 6.0 | 110 | 660 | 8.1 |
| | cluster | | | | | | | before | | | | |
| | | | | | | | | pinching | | | | |
| Example 7 | Third flower | A | 97.1 | 32.6 | D | 0 | 65.3 | 3 days after | 6.0 | 111 | 666 | 7.9 |
| | cluster | | | | | | | pinching | | | | |
| Example 8 | Fourth flower | A | 97.1 | 32.6 | D | 0 | 65.3 | same time as | 8.0 | 114 | 912 | 7.3 |
| | cluster | | | | | | | pinching | | | | |
| Example 9 | Fifth flower | A | 97.1 | 32.6 | D | 0 | 65.3 | same time as | 6.0 | 113 | 678 | 8.3 |
| | cluster | | | | | | | pinching | | | | |
| Example 10 | Third flower | A | 97.1 | 32.6 | D | 0 | 65.3 | 7 days after | 6.0 | 114 | 684 | 6.8 |
| | cluster | | | | | | | pinching | | | | |
| Example 11 | Sixth flower | A | 97.1 | 32.6 | D | 0 | 65.3 | same time as | 12.0 | 113 | 1,356 | 6.6 |
| | cluster | | | | | | | pinching | | | | |
| Comparative | Third flower | A | 97.1 | 32.6 | — | — | — | — | 5.8 | 115 | 667 | 4.8 |
| Example 1 | cluster | | | | | | | | | | | |
| Comparative | Third flower | A | 97.1 | 32.6 | X | 11.3 | 32.6 | same time as | 5.9 | 60 | 354 | 5.3 |
| Example 2 | cluster | | | | | | | pinching | | | | |

As shown in Table 2, in Examples 1 to 11, since the cultivation method includes a cultivation step of cultivating a fruit vegetable plant by irradiating with artificial light and using a hydroponic method, and is characterized in that in a part of a cultivation period in a state where a fruit vegetable plant body has two or more levels of flower clusters or fruit clusters and has two or more leaves with respect to one flower cluster or one fruit cluster, a nutrient solution having a nitrogen concentration of 10 ppm by mass or less is used, a fruit having a high sugar content can be harvested.

On the other hand, in Comparative Example 1, since the nutrient solution was not switched, the sugar content of the fruit was low.

In Comparative Example 2, since a nutrient solution having a nitrogen concentration of 10 ppm by mass or less was not used, the sugar content of the fruit was low.

In Example 4, it was found that since the phosphorus concentration in the nutrient solution used in the second cultivation period was 1.4 times or more the phosphorus concentration in the nutrient solution used in the first cultivation period, the average fruit weight was higher than that in Example 5.

The entire disclosure of Japanese Patent Application No. 2023-025468, filed Feb. 21, 2023, is incorporated into the present specification by reference. In addition, all documents, patent applications, and technical standards described in the present specification are herein incorporated by reference to the same extent that each individual document, patent application, or technical standard was specifically and individually indicated to be incorporated by reference.

What is claimed is:

1. A cultivation method for a fruit vegetable plant, comprising:
a cultivation step of cultivating a fruit vegetable plant by irradiating with artificial light and using a hydroponic method,
wherein in a part of a cultivation period in a state where a fruit vegetable plant body has two or more levels of flower clusters or fruit clusters and has two or more leaves with respect to one flower cluster or one fruit cluster, a nutrient solution having a nitrogen concentration of 10 ppm by mass or less is used.

2. The cultivation method for a fruit vegetable plant according to claim 1,
wherein a start of a use of the nutrient solution having a nitrogen concentration of 10 ppm by mass or less occurs at any time point between 3 days before and 7 days after pinching of the fruit vegetable plant body.

3. The cultivation method for a fruit vegetable plant according to claim 2,
wherein the pinching of the fruit vegetable plant body is performed after flower clusters are formed at three to five levels of the fruit vegetable plant body.

4. The cultivation method for a fruit vegetable plant according to claim 1,
wherein, in a case where a cultivation period in which the nutrient solution having a nitrogen concentration of 10 ppm by mass or less is used is defined as a second cultivation period, and
a cultivation period before the nutrient solution having a nitrogen concentration of 10 ppm by mass or less is used is defined as a first cultivation period,
a phosphorus concentration of the nutrient solution used in the second cultivation period is 1.4 times or more a phosphorus concentration of a nutrient solution used in the first cultivation period.

5. The cultivation method for a fruit vegetable plant according to claim 1,
wherein the fruit vegetable plant is a Solanaceae plant or a Cucurbitaceae plant.

6. The cultivation method for a fruit vegetable plant according to claim 1,
wherein the fruit vegetable plant is a tomato.
